(19) United States
(12) Patent Application Publication
(10) Pub. No.: US 2022/0024285 A1
(43) Pub. Date: Jan. 27, 2022

(54) BLIND FOR VEHICLES

(71) Applicant: RICO BLINDS CO., LTD., Gwangju-si (KR)

(72) Inventors: Sang Gon KIM, Gwangju-si (KR); Young Sam KWON, Seongnam-si (KR)

(73) Assignee: RICO BLINDS CO., LTD., Gwangju-si (KR)

(21) Appl. No.: 17/459,872

(22) Filed: Aug. 27, 2021

Related U.S. Application Data
(63) Continuation of application No. PCT/KR2020/019231, filed on Dec. 28, 2020.

(30) Foreign Application Priority Data
Jul. 27, 2020 (KR) 10-2020-0092882

(51) Int. Cl. B60J 1/20

(52) U.S. Cl. CPC B60J 1/2091

(57) ABSTRACT

The present disclosure relates to a blind for vehicles, which includes: a blind part provided to be transformed in shape by flexibility thereof while having a wrinkled structure to enable expansion in a vertical direction; and a pair of fixing plates provided in a single-pair structure to be attached to each of upper and lower surfaces of the blind part, and functioning as a guide unit guiding a shape transformation by expandability and flexibility while supporting the blind part as well as functioning as a fixing unit to fix a window side of a vehicle.

### CROSS-REFERENCE TO RELATED APPLICATIONS

The present application is a continuation of International Patent Application No. PCT/KR2020/019231, filed on Dec. 28, 2020, which is based upon and claims the benefit of priority to Korean Patent Application No. 10-2020-0092882 filed on Jul. 27, 2020. The disclosures of the above-listed applications are hereby incorporated by reference herein in their entirety.

### BACKGROUND

### 1. Technical Field

The present disclosure relates to a blind for vehicles, and more particularly, to a blind for vehicles that can be used by inserting a fixing plate into a gap of a rubber packing part mounted on a door frame of a vehicle or a window frame of the vehicle, thereby enhancing fixability thereof over the vehicle.

### 2. Description of Related Art

In general, a vehicle awning device is provided on a rear window or side window of a vehicle to block sunlight irradiated into the vehicle or to prevent passers-by or the occupants of other vehicle from seeing into the inside of the vehicle to protect privacy.

The vehicle awning device includes a manual awning device in which an adhesive awning to attach a pad to a window and an awning screen that is wound on a winding roll and is provided so as to be protruded from the winding roll is installed on a vehicle door so that an occupant can manually protrude the awning screen, and an electric awning device provided with a driving unit for protruding the awning screen from the winding roll.

The electric awning device according to the related art is provided with a winding roll on which the awning screen is wound at the bottom of the window, and covers the window while the awning screen is protruded from the winding roll by the driving unit installed on the door.

In recent years, a vehicle blind device of a roll blind type that can be easily used by a vehicle occupant has been widely used, and a vehicle blind device developed according to the shape of a vehicle window so that the vehicle occupant can use it conveniently is being distributed.

In addition, recently, as a vehicle awning unit, products applied with blinds are being released, which are provided on a rear window or side window of a vehicle to block sunlight irradiated into the vehicle or to prevent passers-by or other vehicle occupants from seeing into the inside of the vehicle to protect privacy. A roll blind of an adhesive type for attaching a pad to a window and a roll blind of a manual or electric type wound on a winding roll to be protruded from the winding roll are being commercially distributed.

As such, the conventional blind has a complicated structure, and causes inconvenience when installed and in use.

In addition, conventional blind for vehicles is cumbersome to attach and detach, and blind paper is not firmly fixed.

### SUMMARY

The present disclosure has been devised to obviate the above limitation. An aspect of the present disclosure is directed to providing a blind for vehicles that can be attached and used by inserting a fixing plate into a gap of a rubber packing part mounted on a door frame of a vehicle or a window frame of the vehicle and fixed, thereby enhancing fixability thereof over the vehicle.

An aspect of the present disclosure is directed to providing a blind for vehicles enabling the use of an awning unit at low cost, and enhancing vehicle-side fixability by improving the structure to insert into a gap of a rubber packing part mounted on a window frame or a door frame of the vehicle.

An aspect of the present disclosure is directed to providing a blind for vehicles that anyone can install and freely use the blind for vehicles by simply and easily attaching the blind to the vehicle.

A blind for vehicles according to an embodiment of the present disclosure includes: a blind part provided to be transformed in shape by flexibility thereof while having a wrinkled structure to enable expansion in a vertical direction; and a pair of fixing plates provided in a single-pair structure to be attached to each of upper and lower surfaces of the blind part, and functioning as a guide unit guiding a shape transformation by expandability and flexibility while supporting the blind part as well as functioning as a fixing unit to fix a window side of a vehicle, wherein in each of the pair of fixing plates, a protruding insertion fixing part, to be inserted into a gap of a rubber packing part mounted on a window frame of the vehicle and a door frame of the vehicle and fixed, is provided at any one side of front and rear ends in a length direction.

The protruding insertion fixing part includes an extended protrusion part formed to protrude into two places by being located on both left and right edges in a length direction, or formed to protrude into three places by being located on both left and right edges in a length direction and a central portion, wherein the extended protrusion part may be configured to be integrally formed by extending and protruding on a same plane from an end face of each of the fixing plates.

Each of the extended protrusion part may include at least one or more preliminary folding parts.

The preliminary folding part may be in the form of a straight line or an oblique line, and a mixture of the straight line and the oblique line may be arranged at intervals.

The blind for vehicles further includes: a fixing hole, formed in each of the pair of fixing plates by being located in a central portion in the length direction; a fixing member to which a ring portion is coupled so that the blind for vehicles may be fixedly disposed on a window of the vehicle and used by holding the fixing hole, and may be attached to the window, wherein the fixing member to which the ring portion is coupled uses the pair of fixing plates by matching the fixing hole, and functions as a supporting and fixing unit that allows the blind part having expandability and flexibility to be spread and used in a desired location and area on the window side of the vehicle and to maintain the adjustment state thereof.

The fixing member may be a suction disc including a suction plate using compression rubber exhibiting attachment and fixability using air compression and a ring portion fixedly coupled to the suction plate.

According to the present disclosure, it is possible to simply attach and use a blind for vehicles in a vehicle by inserting a fixing plate into a gap of a rubber packing part mounted on a window frame of a vehicle or a door frame of the vehicle, thereby enhancing fixability thereof over the vehicle.

According to the present disclosure, it is possible to use an awning unit at low cost by lowering manufacturing costs. In addition, by using a fixing plate or fixing unit of a method of insertion into a gap of a rubber packing part mounted on a window frame of a vehicle or a door frame of a vehicle, anyone in the vehicle can easily and simply attach, install, and very freely use the blind for vehicles.

According to the present disclosure, it is possible to broaden the usability and applicability of the blind for vehicles, such as being usable as an awning unit for blocking sunlight not only on driver seat and passenger seat side door windows, but also on front and rear windows.

### BRIEF DESCRIPTION OF THE DRAWINGS

FIGS. 1A and 1B are perspective views illustrating a blind for vehicles according to an embodiment of the present disclosure.

FIG. 2 is a plan view illustrating a fixing plate in a blind for vehicles according to an embodiment of the present disclosure.

FIGS. 3A to 3C are exemplary views illustrating the types that may be manufactured as a blind part in a blind for vehicles according to an embodiment of the present disclosure.

FIG. 4 is an exemplary view illustrating a state in which a fixing plate is inserted and fixedly disposed on a window frame gap of a vehicle in a blind for vehicles according to an embodiment of the present disclosure.

FIG. 5 is a use state diagram illustrating an example using a blind for vehicles according to an embodiment of the present disclosure.

FIG. 6 is a use state diagram illustrating another example using a blind for vehicles according to an embodiment of the present disclosure, and is an exemplary view illustrating a state in which the blind for vehicles is fixed to a window of a vehicle by using a fixing member.

### DETAILED DESCRIPTION

The advantages and features of the present disclosure and methods of achieving them will be apparent from the embodiments that will be described in detail with reference to the accompanying drawings. It should be noted, however, that the present disclosure is not limited to the following embodiments, and may be implemented in various different forms. Rather the embodiments are provided so that this disclosure will be thorough and complete and will fully convey the scope of the present disclosure to those skilled in the technical field to which the present disclosure pertains, and the present disclosure will only be defined by the appended claims.

Terms used in the specification are used to describe embodiments of the present disclosure and are not intended to limit the scope of the present disclosure. In the specification, the terms of a singular form may include plural forms unless otherwise specified. The expressions “comprise” and/or “comprising” used herein indicate the existence of one or more other elements other than stated elements but do not exclude presence of additional elements. Like reference denotations refer to like elements throughout the specification. As used herein, the term “and/or” includes each and all combinations of one or more of the mentioned elements. It will be understood that, although the terms “first”, “second”, etc., may be used herein to describe various elements, these elements should not be limited by these terms. These terms are only used to distinguish one element from another element. Accordingly, a first element mentioned below could be termed a second element without departing from the technical ideas of the present disclosure.

Unless otherwise defined, all terms (including technical and scientific terms) used herein have the same meaning as commonly understood by those skilled in the technical field to which the present disclosure pertains. It will be further understood that terms, such as those defined in commonly used dictionaries, should not be interpreted in an idealized or overly formal sense unless expressly so defined herein.

Preferred embodiments of the present disclosure will be described with reference to the accompanying drawings, and the purpose and configuration of the present disclosure and its features will be better understood through such

### DETAILED DESCRIPTION

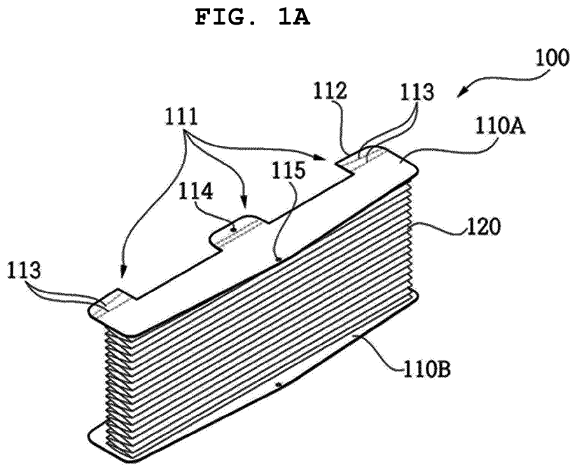

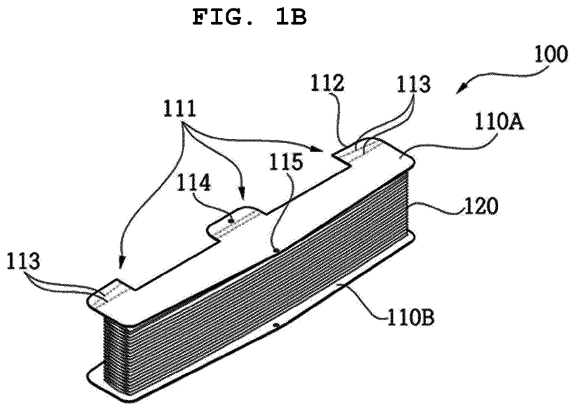

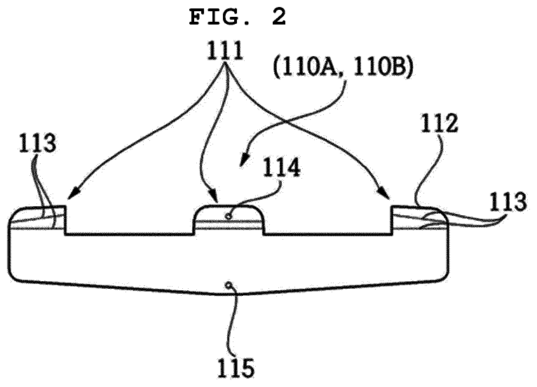

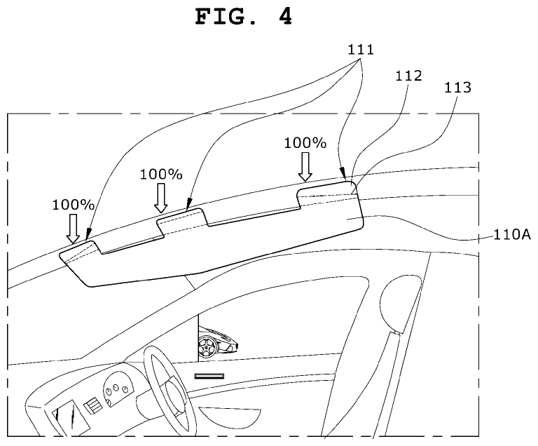

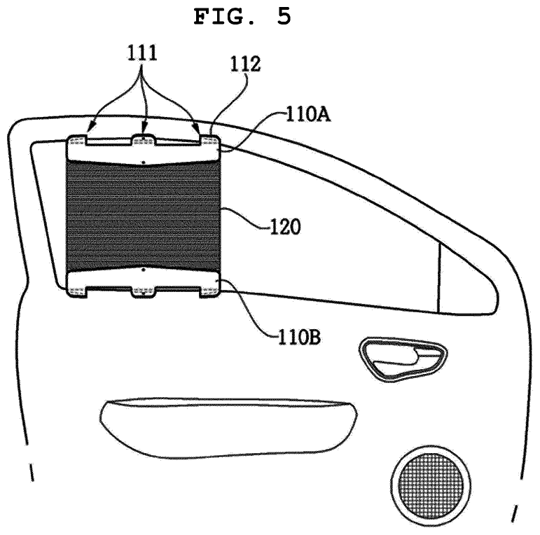

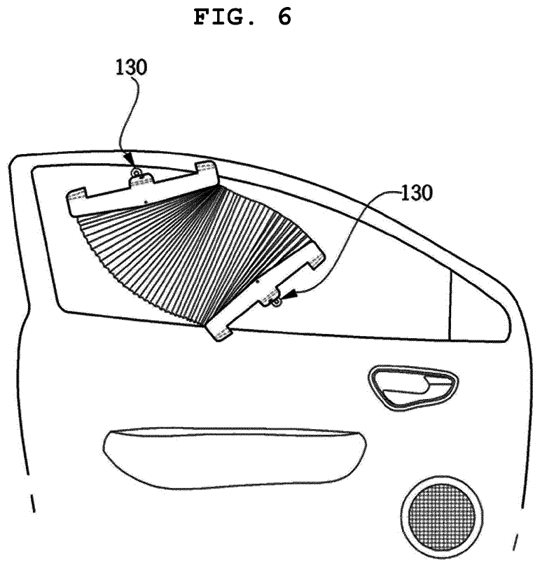

As illustrated in FIGS. 1 to 6, the blind 100 for a vehicle according to an embodiment of the present disclosure includes each of a pair of fixing plates 110A and 110B, and a blind part 120, in addition to a fixing member 130 in order to increase ease of use and convenience thereof.

Each of the pair of fixing plates 110A and 110B is provided in a single-pair structure to be attached to the upper and lower surfaces of the blind part 120, respectively, and functions as a guide unit guiding a shape transformation by flexibility and expandability while supporting the blind part 120 as well as functions as a fixing unit to fix a window side of a vehicle.

In other words, as illustrated in FIGS. 1A and 1, a user may adjust a desired length and shape for the blind unit 120 by moving each of the pair of fixing plates 110A and 110B while holding one of each of the pair of fixing plates 110A and 110B with both hands. Thus, it is possible to freely induce transformation processing and transformation according to the shape of a window side of a vehicle to be used.

In each of the pair of fixing plates 110A and 110B, a protruding insertion fixing part 111 for fixing by insertion into a gap of a rubber packing part mounted on a window frame of a vehicle or a door frame of a vehicle and fixing the same is provided at any one side of the front and rear ends in a length direction.

The protruding insertion fixing part 111 may include an extended protrusion part 112 formed to protrude into two places by being located on both left and right edges in a length direction, or formed to protrude into three places by being located on both left and right edges in a length direction and a central portion.

Each of the extended protrusion part 112 is integrally formed by extending and protruding on the same plane from the end face of each of the fixing plates 110A and 110B.

The protruding insertion fixing part 111 may be formed in the same direction at the front and rear ends of the pair of fixing plates 110A and 110B in a length direction or may be formed in each opposite direction.

In other words, the protruding insertion fixing part 111 forms the extended protrusion part 112 in two or three places, so that it can be easily inserted into a gap of a rubber packing part mounted on a door frame or a window frame of the vehicle through the part protruded as such. Since it has a vehicle side fixing force in a number of places, it is possible to implement fixability that does not come off easily, and to enhance the fixability.

In addition, each of the extended protrusion parts 112 may be provided with a preliminary folding part 113 through at least one or more preliminary folding line processing, so that a portion may be partially folded by bending the portion along a preliminary folding line.

Accordingly, since transformation is induced in accordance with the curved surface and angle of the vehicle-side gap space, a pair of fixing plates 110A and 110B may be inserted into a vehicle side gap and provide more stable fixing force, thereby enhancing fixability.

In other words, it is possible to provide the advantage of not only being able to easily insert the fixing plate regardless of the type of the gap space of the vehicle, but also transforming it to fit its shape even in a curved gap, so that it may be inserted and fixed without difficulty.

Each of the extended protrusion parts 112 may be formed in various shapes including a quadrangle or a trapezoid, and any shape may be possible as long as the shape may enhance fixability.

It is preferable that both edge portions of the extended protrusion parts 112 have the same shape, and the central portion may be formed in a shape different from that of both edge portions in order to hold a balance in the center while enhancing fixing force.

It is preferable that the central portion of the extended protrusion part 112 has a larger area than that of both edge portions.

Here, both edge portions of the extended protrusion part 112 function to enhance fixing force when the blind for vehicles 100 is attached to a vehicle and prevent the pair of fixing plates from being easily separated from a gap space.

The preliminary folding part 113 that may be formed on the extended protrusion part 112 may be configured in a straight line or an oblique shape, and all of them may be mixed and disposed at intervals.

Each of the extended protrusion parts 112 includes at least one or more preliminary folding parts 113, so that the pair of fixing plates 110A and 110B may be more easily inserted into a vehicle side gap in accordance with the curved surface and angle of the vehicle side gap space, and it is possible to provide more stable fixing force and prevent the phenomenon from easily coming out by locking.

Each of the pair of fixing plates 110A and 110B is preferably provided with a synthetic resin material so as to secure fixing force and supporting force for the blind part 120 and to have its own durability, and may be formed to have a thickness of 0.1 mm to 2 mm.

It may be said that each of the pair of fixing plates 110A and 110B may be made of a synthetic resin material of various materials, but in consideration of many factors such as moldability and economic feasibility for low unit price, it may be made of any one selected from polyethylene or polypropylene, or polyolefin polymer or polyvinyl chloride in which they are mixed, and is not particularly limited to these materials.

In this way, through the protruding insertion fixing part 111 including the extended protrusion part 112, by using only the pair of fixing plates 110A and 110B, it may be stably inserted into a gap of a rubber packing part mounted on a door frame of the vehicle or a window frame of the vehicle, and have vehicle side fixability. In this case, there is no need to use tongs or other fixing members.

Each of the pair of plates 110A and 110B may include a configuration in which fixing holes 114 and 115 are additionally formed by being located in the central portion of the upper and lower ends on a planar basis.

The fixing hole may be located on the extended protrusion part 112 formed in the center when the extended protrusion part 112 is formed in the center.

In addition, when the fixing holes 114 and 115 are formed on each of the pair of fixing plates, the fixing holes 114 and 115 are used. The ring portion is coupled so that the blind for vehicles 100 may be fixedly disposed on a window of the vehicle and used by holding any one of the fixing holes 114 and 115, and the fixing member 130 (see FIG. 6) having a structure that may be attached to a window is further included.

In other words, the fixing member 130 to which the ring portion is coupled uses a pair of fixing plates by matching the fixing hole, and functions as a supporting and fixing unit that allows the blind part 120 having expandability and flexibility to be spread and used in a desired location and area on the window side of the vehicle and to maintain the adjustment state thereof

The fixing member 130 may be a suction disc including a suction plate using compression rubber exhibiting attachment and fixability using air compression and a ring portion fixedly coupled to the suction plate.

Each of the fixing holes 114 and 115 may be formed in various shapes such as a circle, an ellipse, or a rectangle, and may be formed to match the fixing member 130, in particular, may be formed to correspond to the shape of the ring portion of the fixing member 130.

When such the fixing member 130 is used, as illustrated in FIG. 6, it is also possible to provide more stable fixability, such as being able to be used in conjunction with a configuration formed on both edge portions of the extended protrusion part 112 in the protruding insertion fixing part 111 according to the location of a gap of a rubber packing part mounted on a door frame of the vehicle or a window frame of the vehicle.

As such, in the present disclosure, the blind for vehicles 100 may be attached to a vehicle using only a pair of fixing plates. Even when the fixing member 130 is used, if necessary, in the protruding insertion fixing part 111, it is possible to provide the advantage of greatly increasing the fixability as well as stable fixability, such as being able to add a fixing force by using both edge portions of the extended protrusion part 112 together.

The blind part 120 is a component that plays a major role in blocking sunlight, has a wrinkled structure so that it may be continuously unfolded and folded in a length direction, and may be transformed in shape by expandability and flexibility.

The blind part 120 may be made of a nonwoven fabric, paper, or traditional Korean paper handmade from mulberry trees.

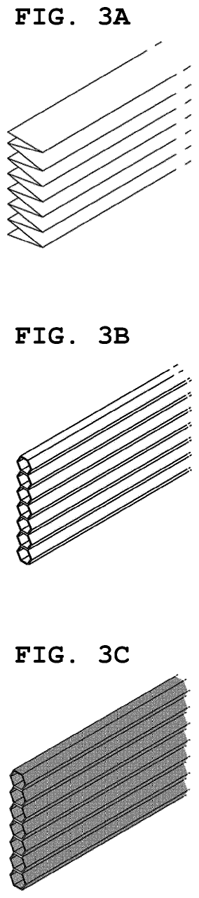

As illustrated in FIG. 3, the blind part 120 may be formed in any one of a sheet type, a honeycomb type, and a mesh type structure, and may sometimes be configured to have a honeycomb type cross-sectional shape and a mesh structure.

It may be said that the blind part 120 is more preferably a nonwoven fabric in order to secure breathability as well as an awning function, and may be a nonwoven fabric made of any one selected from polyester, nylon, polypropylene, viscose rayon, rayon, and hemp nonwoven raw materials.

The blind part 120 may have a porous structure having pores having a size of 5 to 10 nm to block fine dust.

The blind part 120 may be manufactured to exhibit an antibacterial function by adding an antibacterial material to the raw material of the nonwoven fabric, or may be provided to exhibit an antibacterial function by coating a liquid antibacterial material on the nonwoven fabric.

The antibacterial material may use at least one or more of zeolite, rutin, fluorinated illite, graphene, silver nano, terpene, anatase-type titanium oxide, rutile-type titanium oxide, zinc oxide, tin oxide, ferric oxide, bismuth trioxide, tungsten trioxide, and strontium titanate.

The anatase-type titanium oxide, rutile-type titanium oxide, zinc oxide, tin oxide, ferric oxide, bismuth trioxide, tungsten trioxide, and strontium titanate may be said to be a photocatalytic oxide that is excited by the ultraviolet rays of sunlight to exert a self-purifying function and exhibit antibacterial and deodorizing functions.

In addition, the blind part 120 may be attached by coating an aluminum paste on one surface to form an aluminum coating layer or by laminating aluminum paper, and may be configured to reflect sunlight and exert a function to block the inflow of heat into the interior.

The blind part 120 has a wrinkled structure so that it may be continuously unfolded and folded in a length direction, and is provided so as to be able to be transformed in shape by expandability and flexibility.

As described above, the blind for vehicles 100 according to an embodiment of the present disclosure that may be configured as described above includes the blind part 120. Through the pair of fixing plates 110A and 110B for having the protruding insertion fixing part 111, it is possible to enhance the vehicle side stable fixing force and fixability. It is possible to provide more stable fixability by using the fixing member 130 together as needed. There is provided an advantage in that anyone in the vehicle can easily and simply attach, install, and very freely use the blind for vehicles 100.

In addition, when the fixing member 130 is used, it may also be easily used as an awning unit for blocking sunlight not only on a driver seat and passenger seat side windows, but also on the front and rear windows, and may also be used for blocking radiant heat from the dashboard side in a vehicle. Therefore, it is possible to broaden the usability and applicability of the blind for vehicles 100.

The embodiments described above are merely illustrative of preferred embodiments of the present disclosure and are not limited to these embodiments. In addition, it will be appreciated by those skilled in the pertinent technical field that various modifications and variations may be made without departing from the scope and spirit of the present disclosure. It is apparent that this also falls within the scope of the present disclosure.

1. A blind for vehicles comprising:
a blind part provided to be transformed in shape by flexibility thereof while having a wrinkled structure to enable expansion in a vertical direction; and
a pair of fixing plates provided in a single-pair structure to be attached to each of upper and lower surfaces of the blind part, and functioning as a guide unit guiding a shape transformation by expandability and flexibility while supporting the blind part as well as functioning as a fixing unit to fix a window side of a vehicle,
wherein in each of the pair of fixing plates, a protruding insertion fixing part, to be inserted into a gap of a rubber packing part mounted on a window frame of the vehicle or a door frame of the vehicle and fixed, is provided at any one side of front and rear ends in a length direction,
wherein the protruding insertion fixing part includes an extended protrusion part formed to protrude into three places by being located on both left and right edges in a length direction and a central portion, and the extended protrusion part is integrally formed by extending and protruding on a same plane from an end face of each of the fixing plates, and
wherein each of the extended protrusion parts includes a preliminary folding part in which a portion is partially folded by bending the portion along a preliminary folding line through at least one or more preliminary folding line processing,
so that when the protruding insertion fixing part is inserted into the gap of the rubber packing part mounted on the window frame of the vehicle or the door frame of the vehicle, the pair of fixing plates are more easily inserted into a vehicle side gap by inducing transformation in accordance with a curved surface and an angle of a vehicle side gap space and are configured to exhibit more stable fixing force.

2. The blind for vehicles of claim 1, wherein the preliminary folding part is in the form of a straight line or an oblique line, or a mixture of the straight line and the oblique line is arranged at intervals.

3. The blind for vehicles of claim 1, further comprising:
a fixing hole formed in each of the pair of fixing plates by being located in a central portion in the length direction;
a fixing member to which the ring portion is coupled so that the blind for vehicles is fixedly disposed on a window of the vehicle and used by holding the fixing hole, and is attached to the window,
wherein the fixing member to which the ring portion is coupled uses the pair of fixing plates by matching the fixing hole, and functions as a supporting and fixing unit that allows the blind part having expandability and flexibility to be spread and used in a desired location and area on the window side of the vehicle and to maintain the adjustment state thereof.

4. The blind for vehicles of claim 3, wherein the fixing member is a suction disc including a suction plate using compression rubber exhibiting attachment and fixability using air compression and a ring portion fixedly coupled to the suction plate.
